(19) United States
(12) Patent Application Publication
(10) Pub. No.: US 2006/0159799 A1
(43) Pub. Date: Jul. 20, 2006

(54) Nozzle seal with gating needle for injection molding nozzle

(76) Inventor: Panos Trakas, Addison, IL (US)

Correspondence Address: Stephen B. Heller;Cook, Alex, McFarron, Manzo,, Cummings & Mehler, Ltd., 200 West Adams Street - Suite 2850, Chicago, IL, 60606, US

(21) Appl. No.: 11/036,720

(22) Filed: Jan. 14, 2005

(51) Int. Cl. B29C 45/23

(52) U.S. Cl. 425/564

(57) ABSTRACT

An injection molding nozzle is disclosed in which the body has a front end and a central bore terminating at the front end, the front end receiving a needle assembly. The needle assembly has an outer retaining piece adapted to be removeably secured to the front end of the body. The inner piece of the needle assembly is adapted to be received within the outer retaining piece and includes a gating needle that extends through the central opening of the outer retaining piece so as to be in close proximity to the gate of the mold cavity. In one aspect of the invention, the gating needle has a central cylindrical portion with an outer surface that is spaced from the outer retaining piece and at least one melt passageway whose exit is located asymmetrically with respect to the longitudinal axis of the gating needle. In a second aspect, the melt passageway extends linearly and asymmetrically through the gating needle.

### BACKGROUND OF THE INVENTION

The present invention relates to an injection molding nozzle and, and more particularly, to a nozzle seal having a gating needle for an injection molding nozzle.

In injection molding processes, pressurized molten plastic material, or melt, is directed from a heated nozzle through a gate into a mold cavity. Typically, the front end of the nozzle may include either a central gating needle or a “torpedo” that extends past the outlet of the nozzle so as to be in proximity to the gate of the mold cavity. The configuration and composition of the gating needle affects the way the melt behaves around the gate. For example, it is known to make the gating needle of a highly thermally conductive material to improve heat transfer to and from the melt in the gate during the molding cycle. A challenge in designing a gating needle is to simultaneously maximize the rate of heat transfer (namely by maximizing the mass of the conductive material in the needle) and maximize the amount of flow that can pass through the needle to minimize the cycling time (namely by maximizing the size of the melt duct through the needle).

Accordingly, it is an object of the present invention to provide an improved nozzle seal and gating needle for an injection molding nozzle.

More specifically, it is an object of the present invention to provide a gating needle for use in a nozzle seal in which the needle provides both high heat transfer rates and high melt flow rates.

### SUMMARY OF THE INVENTION

These objects, as well as others that will become obvious upon reference to the following detailed description and accompanying drawings, are attained by a needle assembly that is used in an injection molding nozzle which has an outer retaining piece with a central opening adapted to be removably secured to the front end of the nozzle and a gating needle adapted to be secured to the nozzle by the outer retaining piece. The gating needle includes a longitudinal axis and comprises an intermediate cylindrical portion that is symmetrical about the longitudinal axis, a generally conical portion extending axially from one side of the intermediate portion and terminating in a solid point, and a generally cylindrical stem extending axially from the intermediate portion in the direction opposite to that of the conical portion. At least one melt passageway extends linearly (i.e., in a straight line) through the gating needle from the stem through the intermediate portion and exiting in the conical portion rearward of the point of the tip. The exit of the melt passageway is located asymmetrically with respect to the longitudinal axis (i.e., not coterminous with the longitudinal axis) of the gating needle so that the tip of the needle terminates in a solid point.

In another aspect of the invention, the central portion of the gating needle has a diameter such that the outer surface of the intermediate portion is spaced from the adjacent surface of the outer retaining piece. The lower portion of the gating needle may also be spaced from the interior sidewall of the outer retaining piece.

### BRIEF DESCRIPTION OF THE DRAWING

FIG. 1 is an elevational view of an injection molding nozzle, in partial cross-sectional view, embodying the present invention.

FIG. 2 is an enlarged cross-sectional view of the front end of the nozzle of FIG. 1.

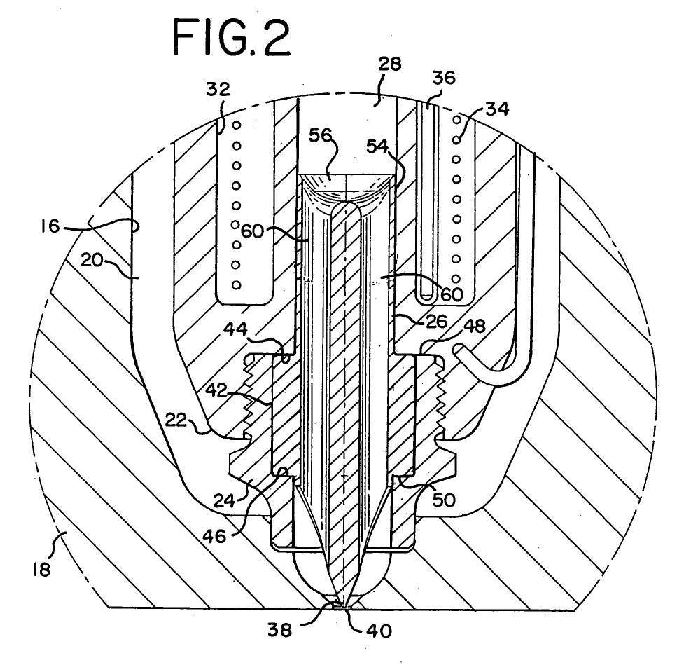

FIG. 3 is an enlarged cross-sectional view of the front end of a nozzle having an alternate embodiment of the present invention.

FIGS. 4-6 are enlarged cross-sectional views of various embodiments of a gating needle in accordance with the present invention.

FIGS. 7-9 are top views of the gating needles shown in FIGS. 4-6, respectively.

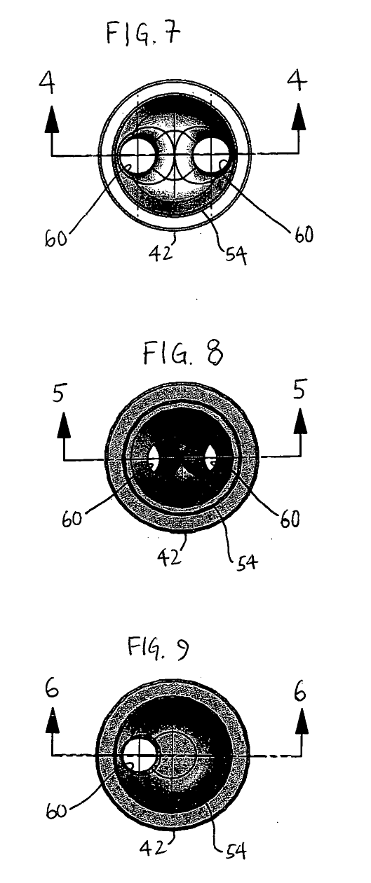

### DETAILED DESCRIPTION

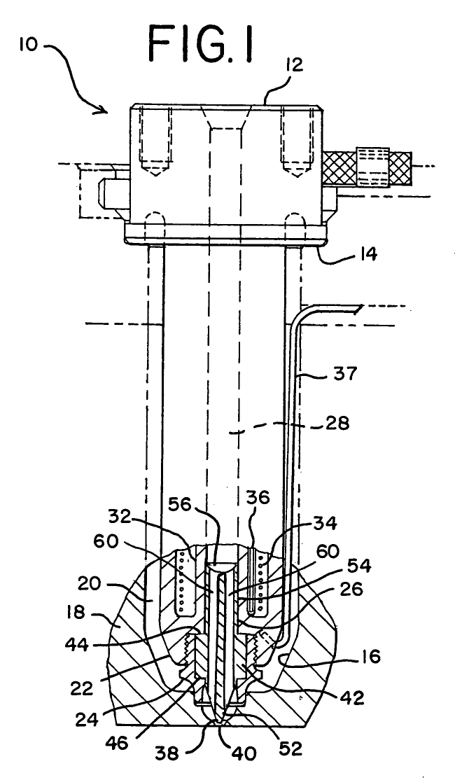

Turning to the drawings, there is seen in FIG. 1 a heated nozzle 10 for use in connection with a multi-cavity injection molding system (not shown). Multi-cavity injection molding systems are well known in the art, as exemplified by, e.g., U.S. Pat. Nos. 5,147,663 and 4,900,560 to Trakas, which are incorporated herein by reference. Several such heated nozzles 10 are inter-connected by a melt distribution manifold to facilitate the introduction of melt through a series of gates into a mold cavity.

As is typical, the nozzle 10 includes a rear end 12 that abuts the front face of the melt distribution manifold. The nozzle 10 includes a locating flange 14 that seats on a shoulder in the well 16 of the manifold plate (shown in partial fragment at 18), thus forming an insulative air space 20 between the heated nozzle 10 and the cooled mold 16.

The nozzle 10 includes a threaded front end 22 that receives a nozzle seal. The nozzle seal comprises a complimentarily threaded outer retaining piece 24 and a gating needle 26. Preferably, the outer or retaining piece 24 of the nozzle seal is of a material that is thermally less conductive than the gating needle 26, which, as discussed above, is of a thermally highly conductive material.

The nozzle 10 includes a central bore 28 that is in fluid communication with the melt passage of the manifold so as to convey melt therethrough. The melt then flows through a melt duct or passageway (described in greater detail below) in the gating needle 26. The nozzle 10 includes a heater cavity 32 that receives an electrical heating element or core 34 and a thermocouple 36. The nozzle 10 may also optionally include a thermocouple 37 supported on its outer surface so as to reside in the insulative air space 20.

As described in U.S. Pat. No. 5,055,028 to Trakas, which is incorporated by reference herein, the volume of the heater cavity 32 not occupied by the heater core 34 and thermocouple 36 is preferably filled with a substantially void-free, compacted particulate refractory ceramic material such as, for example, magnesium oxide. As described in the referenced patent, the ceramic refractory material of choice, magnesium oxide, provides excellent heat transfer capabilities at high temperatures when it is compacted.

As illustrated, the tip 38 of the gating needle 26 terminates in a point that extends through the distal opening in the outer piece 24. When the nozzle is positioned in the mold 18, the tip 38 of the gating needle 26 is disposed in close proximity to the mold gate 40, through which melt enters into the mold cavity.

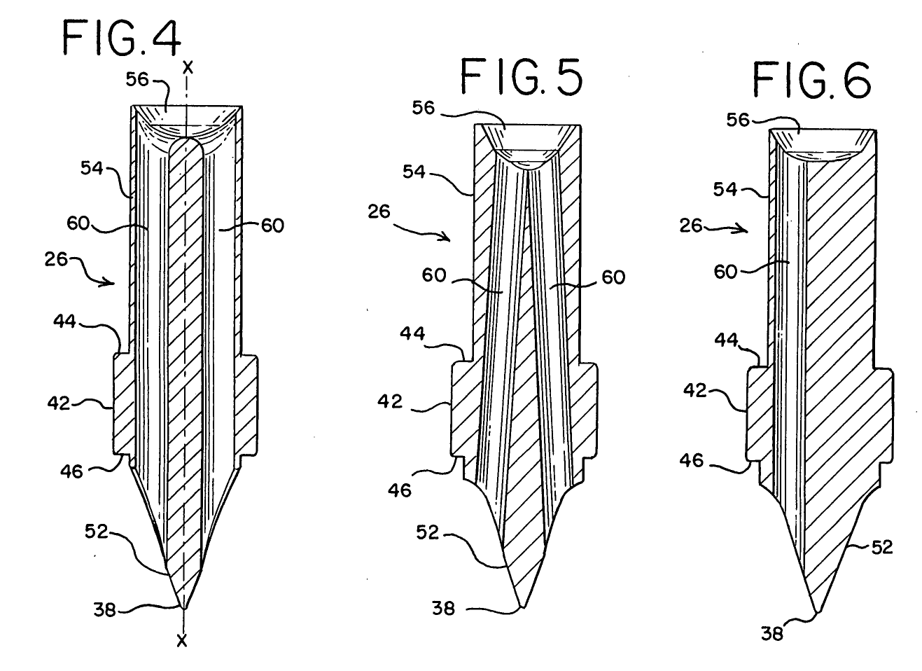

As best seen in FIG. 4, the gating needle 26 is generally symmetrical with respect to its longitudinal axis X-X and is formed with an intermediate portion 42 that is radially enlarged with respect to both the central bore 28 of the nozzle 10 and the front opening of the outer piece 24. Thus, the central portion 42 of the inner piece 26 has opposed shoulders 44, 46 that are received between cooperating shoulders 48, 50 on the interior of the front end 22 of the nozzle and on the interior of the retaining piece 24, respectively.

Extending axially from the shoulder 46 and generally symmetrically with respect to the longitudinal axis X-X is a generally conical portion 52 that terminates in the tip 38 of the gating needle 26. Extending axially from the shoulder 44 and generally symmetrically with respect to the longitudinal axis X-X is a stem 54. The stem 54 preferably terminates in a concave surface 56, but may alternatively be flat (i.e., perpendicular to the side wall of the stem) or convex. The outside diameter of the stem 54 is closely dimensioned with respect to the inside diameter of the central bore 28 of the nozzle 10 to help accurately center the tip 38 of the needle 26 with respect to the gate 40.

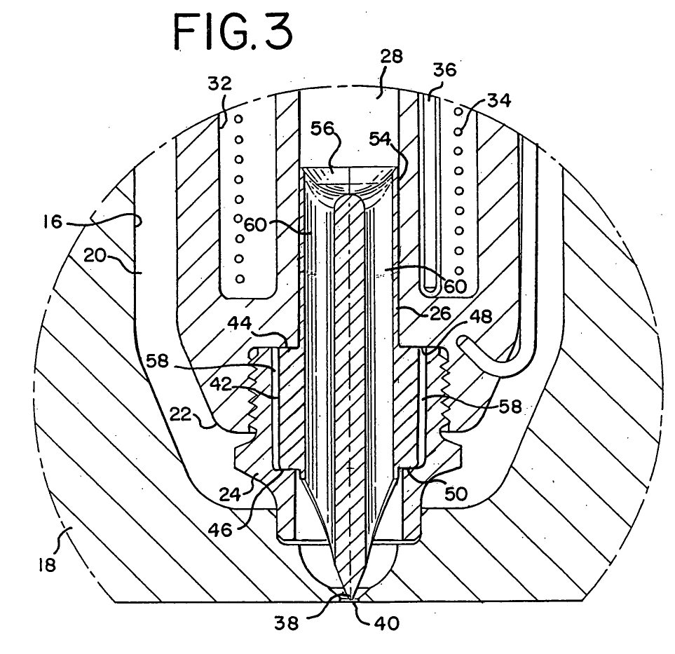

In keeping with an aspect of the invention, the outside diameter of the intermediate portion 42 of the gating needle is smaller that the inside diameter of the outer piece 24 (best seen in FIG. 3) so that, when the nozzle seal is assembled on the nozzle 10, there is an air space 58 between the central portion of the gating needle 26 and the outer piece 24. The air space 58 helps to further insulate the highly conductive gating needle 26 with respect to the low conductivity outer piece 24, thus further reducing the heat transfer from the needle 26 to the outer piece 24, and consequently reducing the heat transfer to the mold. Similarly, the lower portion of the gating needle 26 may be spaced from the interior sidewall of the outer retaining piece 24 (also best seen if FIG. 3).

In keeping with another aspect of the invention, the gating needle 26 includes at least one off-center melt passageway that extends linearly (i.e., in a straight line) from the concave surface 56 of the stem 54, through the intermediate cylindrical portion 42, and exits through the conical section 52. Importantly, the exit is located asymmetrically with respect to the longitudinal axis X-X of the gating needle 26 so that the pointed tip of the needle remains intact.

Preferably, the gating needle 26 includes two linear melt passageways 60 (as best seen in FIGS. 4 and 5). As seen in FIG. 4, the passageways 60 are generally parallel to each other and to the longitudinal axis X-X of the gating needle 26. Alternatively, as seen in FIG. 5, the axes of the two passageways 60 are coplanar and form an acute angle with respect to each other, the angle opening from the stem 54 to the conical portion 52 of the gating needle. In both the embodiments of FIGS. 4 and 5, the longitudinal axis X-X of the gating needle 26 lies in a plane defined by the axes of the two melt passageways 60.

In a further alternate embodiment, shown in FIG. 6, the gating needle 26 has a single linear passageway 60 that is parallel to the longitudinal axis X-X of the gating needle 26. As can be appreciated, varying the number and configuration of the passageways 60 affects the pressure drop across the gating needle 26.

The entrances to the passageways 60 lie in the concave portion 56 of the stem 54, and the juncture between the concave portion 56 and the entrance to each passageway is preferably beveled to facilitate the flow of melt from the central bore 28 of the nozzle 10 into the gating needle 26.

Thus, a needle assembly has been provided that meets all the objects of the present invention. While the invention has been described in terms of a preferred embodiment, there is no intent to limit it to the same. Instead, the invention is defined by the scope of the following claims.

What is claimed:

1. A needle assembly for use in an injection molding nozzle, the nozzle comprising a body with a front end and a central bore terminating at the front end for passage of melt into a mold gate, the needle assembly comprising:
an outer retaining piece having a central opening and adapted to be removeably secured to the front end of the nozzle body;
a gating needle adapted to be secured to the nozzle body by the outer retaining piece, the gating needle having a central longitudinal axis and comprising:
an intermediate cylindrical portion, the outer surface of which is symmetrical about the central longitudinal axis, and having opposed shoulders for facilitating securement of the gating needle to the nozzle body;
a generally conical portion extending axially from one side of the central portion and terminating at the forward end thereof in a solid pointed tip, the conical portion being generally symmetrical about the central longitudinal axis;
a generally cylindrical stem extending axially from the intermediate portion in a direction opposite to the conical portion, the stem terminating in an end surface, the outer surface of the stem being generally symmetrical with respect to the central longitudinal axis; and
at least one melt passageway extending linearly from the end surface of the stem, through the intermediate portion and having an exit in the conical portion, the exit being located rearwardly of the pointed tip and asymmetrically with respect to the longitudinal axis.

2. The needle assembly of claim 1 wherein the outer surface of the central cylindrical portion of the gating needle is spaced from the outer retaining piece.

3. The needle assembly of claim 1 in which the melt passageway of the gating needle is in substantially parallel alignment with the longitudinal axis of the gating needle.

4. The needle assembly of claim 1 wherein the gating needle comprises two melt passageways disposed in co-planar relation with respect to each other and with respect to the longitudinal axis of the gating needle.

5. The needle assembly of claim 4 in which each of the two passageways of the gating needle has a longitudinal axis, the longitudinal axes of the passageways defining an acute angle.

6. The gating needle of claim 1 wherein the end surface of the stem is concave.

7. The gating needle of claim 1 wherein the end surface of the stem is flat.

8. The gating needle of claim 1 wherein the end surface of the stem is convex.

9. A needle assembly for use in an injection molding nozzle, the nozzle comprising a body with a front end and a central bore terminating at the front end for passage of melt into a mold gate, the needle assembly comprising:
an outer retaining piece having a central opening and adapted to be removably secured to the front end of the nozzle body;
a gating needle adapted to be secured to the nozzle body by the outer retaining piece, the gating needle having a central longitudinal axis and comprising:
an intermediate cylindrical portion, the outer surface of which is symmetrical about the central longitudinal axis, and having an outer surface spaced from the outer retaining piece and opposed shoulders for facilitating securement of the gating needle to the nozzle body;
a generally conical portion extending axially from one side of the central portion and terminating at the forward end thereof in a solid pointed tip, the conical portion being generally symmetrical about the central longitudinal axis;
a generally cylindrical stem extending axially from the intermediate portion in a direction opposite to the conical portion, the stem terminating in an end surface, the outer surface of the stem being generally symmetrical with respect to the central longitudinal axis; and
at least one melt passageway extending from the end surface of the stem, through the intermediate portion and having an exit in the conical portion, the exit being located rearwardly of the pointed tip and asymmetrically with respect to the longitudinal axis.

10. The needle assembly of claim 9 wherein the melt passageway of the gating needle extends linearly through the stem, central portion, and conical portion.

11. The needle assembly of claim 9 in which the melt passageway of the gating needle is in substantially parallel alignment with the longitudinal axis of the gating needle.

12. The needle assembly of claim 9 wherein the gating needle comprises two melt passageways disposed in co-planar relation with respect to each other and with respect to the longitudinal axis of the gating needle.

13. The needle assembly of claim 12 in which each of the two passageways of the gating needle has a longitudinal axis, the longitudinal axes of the passageways defining an acute angle.

14. The needle assembly of claim 9 in which the end surface of the stem of the gating needle is concave.

15. The needle assembly of claim 9 in which the end surface of the stem of the gating needle is flat.

16. The needle assembly of claim 9 in which the end surface of the stem of the gating needle is convex.
